(19) United States
(12) Patent Application Publication
(10) Pub. No.: US 2009/0083105 A1
(43) Pub. Date: Mar. 26, 2009

(54) Meeting Coordination System with Dependency Rules for Alternate Meeting Processing

(76) Inventors: Kulvir Singh Bhogal, Fort Worth, TX (US); Robert Ross Peterson, Austin, TX (US)

Correspondence Address: The Brevetto Law Group, PLLC, 838 Maine Street, Quincy, IL, 62301, US

(21) Appl. No.: 11/858,986

(22) Filed: Sep. 21, 2007

(51) Int. Cl. G06Q 10/00

(52) U.S. Cl. 705/8

(57) ABSTRACT

Methods and systems are provided for setting up a meeting schedule for people whose representation at the meeting is essential to holding the meeting. If the person whose representation at the meeting is essential can be represented by someone else at the meeting, the system sets up a predefined dependency rule for the second person to fill in for the essential attendee in their absence. When the system sends out meeting invitations, for example, by email, the essential person's attendance is subject to the dependency rule. In this way, if the first person cannot attend the meeting but the second person is able to attend, the meeting can be carried out. Sending out meeting invitations with such a predefined dependency rule simplifies the logistics of setting up a meeting to be attended by a number of individuals with full schedules.

### BACKGROUND

1. Field

The present invention relates to office communication and automation systems, and more specifically, to automated systems, methods and computer products for scheduling meetings.

2. Background

Meetings among employees are essential to conducting business. Nearly all businesses and organizations rely on meetings to some extent to plan projects, conduct operations, report results, and make business decisions. Voicemail and email are very useful business tools that make communications more convenient. However, the convenience of voicemail and email cannot replace real-time interfacing between employees in many situations. For this reason, the need to schedule and conduct meetings will not soon go away. Yet, the busy schedules and time constraints of today's workers make scheduling a meeting an increasingly difficult task.

A meeting may be scheduled using an automated tool such as Microsoft Outlook™ to coordinate the schedules of individual attendees and work out scheduling conflicts. To schedule a meeting using Outlook™ an email is sent out to all attendees with a proposed time for the meeting. The individual attendees may be labeled as “Required Attendance” or “Optional Attendee.” Outlook™ detects scheduling conflicts and seeks to resolve them based on open appointments in the individual attendee's Outlook™ calendar. Other tools for scheduling meetings are available, including Apple Automator™ and Google's™ calendar feature. These conventional tools can also be used to schedule meetings, and have similar capabilities to Microsoft Outlook™ for detecting and resolving the scheduling conflicts of the individuals invited to the meeting.

It is often the case that the desired attendance for meetings is more complex than can be expressed with categories such as “Required” or “Optional.” The present inventors realized that the meeting attendance decisions of some employees may affect whether or not the attendance of other employees is required in order to continue setting up the meeting. In conventional systems it is left to the meeting scheduler to recognize and enforce these dependencies manually. This means that conventional systems require the person setting up the meeting—the meeting scheduler—to constantly monitor the list of invitees who have accepted or rejected their meeting notices. What is needed is a more flexible and efficient tool for scheduling meetings that considers attendance dependencies during the process of setting the meeting up.

### SUMMARY

Embodiments disclosed herein address the above stated needs by providing systems, methods and computer products for scheduling meetings. For example, various embodiments provide systems, methods and computer products that send a meeting invitation to the invitees of a meeting, wherein the meeting is contingent upon a dependency rule associated with at least one invitee's attendance. Typically, the meeting invitation specifies a time and place for the meeting. The system receives responses back from at least some of the invitees, including positive responses from the invitees subject to the dependency rule. In response to receiving these acceptances for the meeting back, the system can continue setting up the meeting.

In at least some situations a dependency rule is included that specifies that a given invitee must attend the meeting in place of another invitee who cannot attend. In other situations, the dependency rule may specify that the second invitee must attend the meeting if the first invitee also attends the meeting. Various embodiments include sending out a final meeting notice to confirm the time and place for the meeting, wherein the final meeting notice is sent once positive responses have been received from all mandatory attendees, or in some embodiments, any invitees subject to the conditions of a dependency rule.

### BRIEF DESCRIPTION OF THE DRAWINGS

The accompanying drawings, which are incorporated in and constitute part of the specification, illustrate various embodiments of the invention. Together with the general description, the drawings serve to explain the principles of the invention. In the drawings:

FIG. 1 depicts exemplary activities in setting up and implementing embodiments of a meeting coordination system with dependency rules;

FIG. 2 is a flowchart depicting a method of preparing an invitation with dependency rules according to various exemplary embodiments;

FIG. 3 is a flowchart depicting a method of sending invitations with dependency rules and setting up a meeting according to various exemplary embodiments; and

FIG. 4 is an information technology system suitable for practicing various exemplary embodiments.

### DETAILED DESCRIPTION

Sometimes one employee's decision of whether or not to attend a meeting may affect the requirement for another employee to be in attendance, in order for the meeting to be carried out. One employee's required attendance due to another employee's absence (or attendance) is an example of a dependency rule for the invitees to the meeting. Consider, for example, a meeting with four invitees (e.g., potential attendees), Alice, Bob, Charlie and Lynn. It may be the case that Lynn and Alice both do not have to attend the meeting, but one of them must attend in order for the meeting to take place. That is, if Lynn cannot attend the meeting, then Alice's attendance is required or else the meeting must be canceled or rescheduled. This may occur if Lynn is an executive in a company, and Alice is a trusted subordinate who can take Lynn's place in her absence. Another situation in which this may occur is if Alice and Lynn are both co-workers in the same department (e.g., the finance department), and one of them must attend in order to represent the department at the meeting. As another example, Alice and Bob or Charlie and Lynn may be sufficient to hold the meeting but not Charlie and Bob. In yet another example of a dependency rule, if Lynn is able to attend, the meeting may proceed only if Alice is also able to attend. Such a situation may occur, for instance, if Lynn is a negotiator trying to close a foreign business deal and Alice is Lynn's translator versed in the language of the potential client. Many other such examples exist for attendance dependency rules associated with an invitee's attendance to a meeting. An attendance dependency rule is a requirement that, based on one invitee's ability to attend a meeting or not, the meeting may proceed only if another specified invitee is able to attend. For example, if one invitee cannot attend a meeting, the meeting may proceed only if another specified invitee is able to attend. The various embodiments disclosed herein provide an automated way of setting up a meeting that includes invitees subject to a dependency rule.

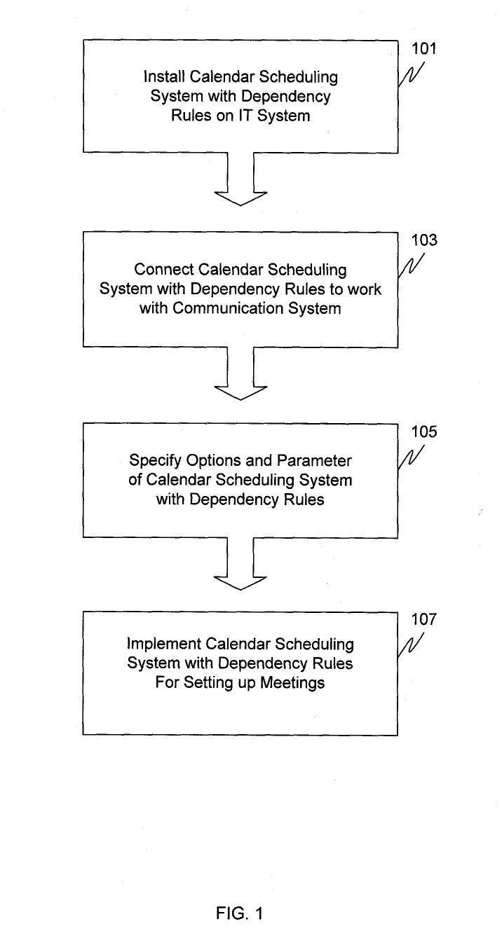

FIG. 1 depicts a number of exemplary activities involved in setting up and implementing a meeting coordinator system with dependency rules according to various embodiments. The activity in 101 involves installing the meeting coordinator system on an information technology (IT) system such as a computer system of the person who will be sending out the meeting invitations. Depending upon the implementation, the meeting coordinator system may work in conjunction with an existing application to provide additional dependency rule functionality, or may exist as a stand-alone application providing calendaring functions and communication capabilities. For example, various embodiments of the meeting coordinator system provide email capabilities in addition to calendaring functions. One popular conventional application, Microsoft Outlook™, provides both email capability and calendar functions, allowing one to send out meeting invitations to others and collect the responses via email. However, as mentioned above in the Background, the prior art lacks the capability to set up meetings for invitees subject to dependency rules, as described below. Depending upon the particular implementation of the present invention, the various embodiments may be used in conjunction with a conventional email/calendar application (such as Outlook™) to supplement its capabilities and provide the ability to set up a meeting with invitees subject to dependency rules. In other embodiments, the various embodiments of the meeting coordinator with dependency rules disclosed herein may be implemented as a stand-alone application, providing both communication capabilities to send meeting invitations (e.g., email) and a calendaring function for setting up meetings and tracking schedules.

The activities of 101 typically entail installing the application software of the meeting coordinator system from a computer product source provided by the vendor, or from another source. For example, the application software may be downloaded from the Internet, received as an email attachment, or uploaded from a CD, diskette, or other machine readable storage device suitable for storing the application software. Once the application software has been obtained, it is loaded on to a computer or other information handling device accessible by the person who will be sending the meeting invitations. It is not necessary that all invitees who may receive meeting invitations have application software for the meeting coordinator with dependency rules loaded onto their system. The invitees need only have the capability to receive the invitation and reply back with a response. In some instances, the person coordinating the meeting may be the only one with the application software for the meeting coordination system loaded onto their computer (or other IT device). In other instances, the meeting coordinator with dependency rules may be incorporated into every (or many) invitee's email and/or calendaring application. The meeting coordinator with dependency rules system is often an application software product purchased or acquired by a company and installed on a computer system of the individual who will be sending out the meeting invitations. In alternative embodiments, the meeting coordination system may be run remotely, for example, via a network of the company or as an Internet application accessible at a website. Upon completing the installation of the application software, or otherwise providing access to the system, the method proceeds from 101 to 103.

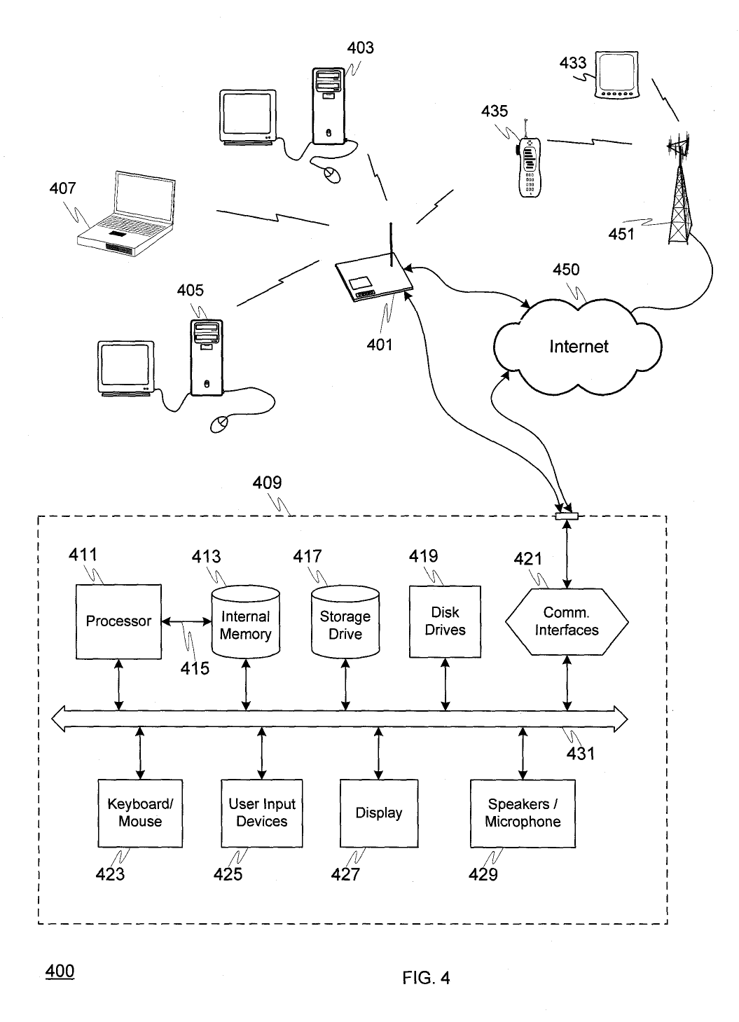

In 103 the meeting coordinator system is provided access to communication links for sending the meeting invitations and receiving responses back from invitees. Various embodiments use email as a means of communicating meeting invitations. Such an email invitation may be sent using a communication system of the company such as the company's network, phone system or other communication links. As an alternative to using a communication system of the company (or in addition to), the various embodiments may also use a communication system unrelated to a particular company or organization, such as the Internet, the public switched telephone network (PSTN) or any other such communication system. In lieu of email, the various embodiments may be configured to use text messaging, instant messaging, recorded telephone messages, or other like kinds of communication known to those of ordinary skill in the art to be suitable for sending meeting invitations and receiving responses back. In any case, the meeting coordinator with dependency rules should be set up to provide communications to/from the meeting invitees using some communication system for the meeting invitations. Generally, responses are received back via the same communication system used to send the invitations, although this is not an absolute requirement. For example, the invitation may be sent out by email with an option provided to dial in to a telephone system for responding back, or with an option to respond via the Internet, by sending a text message, or other like means of communication. FIG. 4 depicts further details of a typical information handling device and communication system suitable for use with the various embodiments. Once the meeting coordinator system has been set up to communicate with potential invitees, the method proceeds from 103 of FIG. 1 to 105.

In 105 the various options and parameters are set up for the meeting coordinator system. This typically entails entering default settings for the system, to avoid the need to enter such data each time a meeting invitation is sent out. For example, one of the activities of 105 may be to provide the default language used in the email meeting invitations. In this way, the person sending out the invitation would only need to enter information specific to a particular meeting (e.g., topic, time, date place, etc.). Another parameter set up in 105 may be settings for whether or not the dependency classifications are disclosed for all invitees receiving a meeting invitation, that is, whether the invitation shows whose attendance is considered mandatory (or isn't considered mandatory) for the meeting, and/or the various dependency rules for people backing up the mandatory attendees. One other parameter may involve setting up the menuing system and prompts that are shown when a person begins preparing a meeting invitation. The application software can be set to provide more detailed prompts and instructions initially until the person using the application is familiar with the data entries, at which time the prompts and instructions can be disabled to save time for the knowledgeable user. In addition to these types of format parameters, the activities of 105 may include the provisioning of an address book listing potential invitees. The address listings for each potential invitee may specify a preferred means of communication. For example, some invitees may prefer receiving an email invitation at their company email address. Others may prefer to receive a text message invitation sent to their mobile telephones. One additional input in 105 may be to specify default substitute invitees for given attendees of meetings. For example, a default rule may be set up in advance specifying that, in the event Lynn cannot attend a meeting, then Alice is authorized to stand in for Lynn in her place. Once 105 has been completed and the default settings and parameters for the system have been specified, the method proceeds to 107.

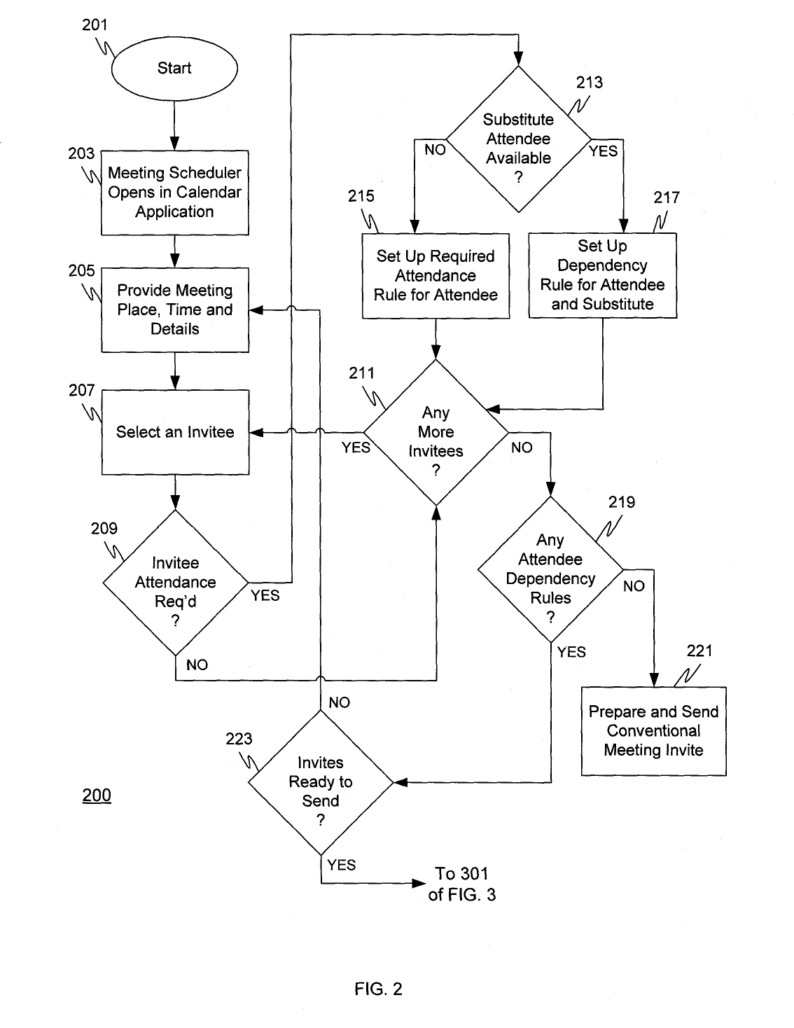

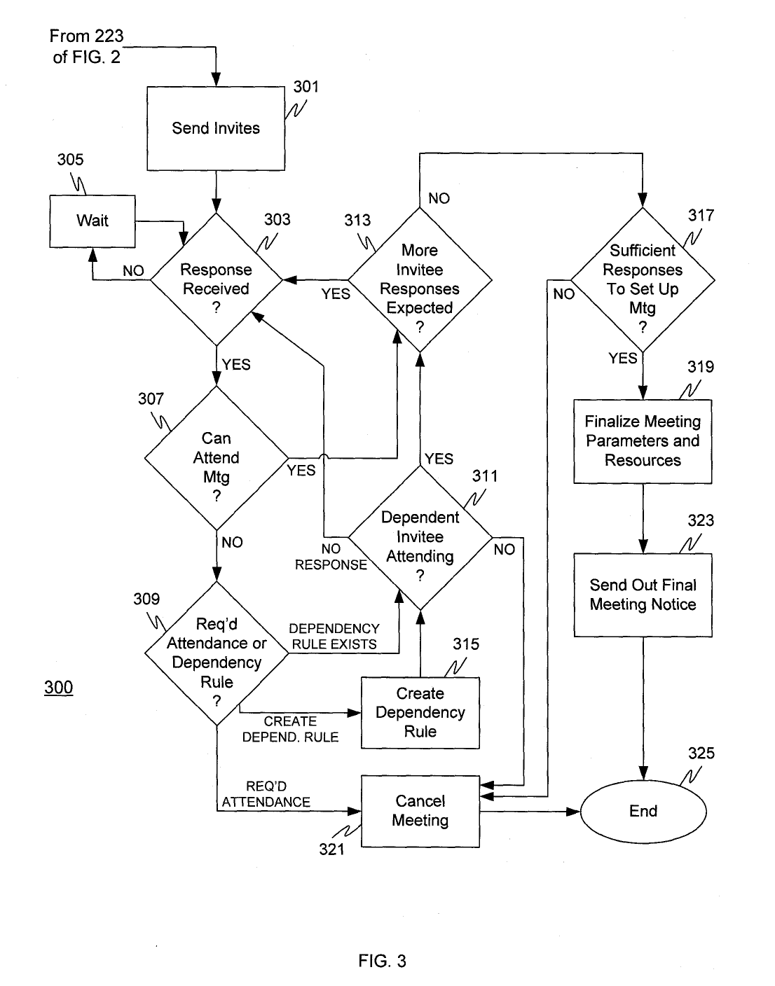

In 107 the meeting coordinator system with dependencies is implemented so that a user sending out a meeting invitation may set up dependency rules for the meeting to ensure that the personnel required for the meeting, or a suitable replacement, will be in attendance. FIG. 2 shows further details for setting up a meeting invitation with dependency rules. FIG. 3 shows further details for monitoring the responses and setting up the meeting once the meeting invitations with dependency rules have been sent out.

FIG. 2 is a flowchart depicting a method 200 of preparing an invitation with dependency rules according to various exemplary embodiments. The method begins in 201 and proceeds to 203 where the meeting scheduler is opened, or the meeting coordinator system is otherwise started up to begin preparing a meeting invitation with dependencies. The method proceeds to 205 where the details and prerequisites of the meeting are entered, including for example, the meeting topic, time, place, meeting agenda, any required materials/facilities (e.g., viewgraphs, charts, data inputs, etc.), and other resources needed to hold the meeting. The meeting prerequisites may include activities such as specifying that certain attendees have read through a design document or have attended necessary training before the meeting. Such prerequisites help to enhance the productivity of the meeting. Once the meeting details have been entered, the method proceeds to 207.

In 207 the system receives an input for an invitee to the meeting-that is, one of the people who will receive a meeting invitation. In some implementations this may be done by detecting that the user has selected an invitee from an address book of the meeting coordinator system or other email application or communication system being used to send the invitations. Another way of selecting invitees may be to use a predefined invitee distribution list. For example, a company may have a marketing distribution list that includes the sales and marketing executives of a company responsible for the firm's marketing endeavors to be invited to marketing meetings. Once an invitee has been specified in 207 the method proceeds to 209.

In 209 it is determined whether the invitee's attendance (or a substitute's attendance) is required in order for the meeting to be held-that is, whether the invitee's (or substitute's) attendance is mandatory for the meeting to take place. In some instances, the person setting up the meeting might specify a need for a given number of people with certain competencies to attend the meeting in order for the meeting to take place. For example, the meeting may require at least two architects, one development team lead, and one business analyst attend the meeting, or else the meeting should be canceled or rescheduled. Thus, the requirement for mandatory attendance may either be tied to a particular individual, or may be tied to a certain competency or skill set (e.g., architect(s), development team leader(s), business analyst(s)), or to an office within the organization (e.g., vice president, comptroller, lobbyist). If it is determined in 209 the invitee's attendance is not required for the meeting to be held, the method proceeds from 209 via the “NO” branch to 211 to determine whether any more invitations are to be sent out for the meeting. If there are more invitees the method loops back from 211 via the “YES” branch to 207 to select another invitee. Back in 209, if it is determined that the invitee's attendance is needed for the meeting, the method proceeds from 209 via the “YES” branch to 213. In 213, for a required invitee, it is determined whether the invitee can be replaced by a substitute at the meeting—that is, whether a substitute invitee is available if the meeting can be held in the invitee's absence. In some implementations this may be determined ahead of time, before sending out the invitations. In other implementations, the substitute may be decided upon after the invitation is sent out and it is determined that the required invitee cannot attend. For example, if a required invitee cannot attend a meeting upon receiving the invitation, the invitee may specify a substitute to take his (or her) place at the meeting.

Returning to 213, if an invitee's attendance is required but no substitute is available, the method proceeds from 213 along the “NO” path to 215. In 215 a required attendance rule is specified stating that if the required invitee cannot attend the meeting, then the meeting must be rescheduled or otherwise re-coordinated to accommodate the invitee's attendance, or else the meeting must be canceled. Back in 213, if an invitee's attendance is required and there is a substitute who may be available, the method proceeds from 213 along the “YES” path to 217 to create a dependency rule for the required invitee and potential substitute. The dependency rule may be something to the effect: “If Lynn is required but cannot attend the meeting, Alice can take Lynn's place.” At this time, dependency rules for other situations may be set up as well. One such dependency rule may be that: “Lynn is required to attend, but the meeting cannot be held unless Alice also attends the meeting.” Other situations exist that call for dependency rules. For example, Bob and Charlie's attendance may be mutually exclusive. That is, “One of either Bob or Charlie's attendance is required, but the meeting cannot be held with both Bob and Charlie present.” This could be the case if the executives of a professional football team planned to meet at different times with the agents of two different players who were considering signing a contract with the team for the same position. The team may not want to meet with both agents—Bob and Charlie—together at the same meeting if only one player is to be signed for a given position (e.g., one quarterback). In order to proceed, however, the meeting must have at least one of the player's agents. In this last example, the dependency rule may affect the order of sending out the meeting invitations. For instance, since both Bob and Charlie cannot attend the same meeting in this example, the person setting up the meeting may set up a dependency rule to first send Bob an invitation, and if Bob cannot attend, then, and only then, send an invitation to Charlie.

Once the dependency rules have been specified in 217 the method proceeds to 211 to determine whether any more invitees are to be added to the list for sending out meeting invitations. If there are more invitees, the method proceeds from 211 along the “YES” branch to 207 to select another invitee and start the process of creating a dependency rule over again. However, if it is determined in 211 that there are no more invitees, the method proceeds from 211 along the “NO” path to 219. In 219 it is determined whether the creation of the meeting invitation for the list of invitees resulted in any dependency rules being created. If there are no dependency rules associated with the meeting invitation, the method proceeds from 219 along the “NO” path to 221 to prepare and send a conventional meeting invitation. However, if there is a dependency rule associated with at least one of the invitees, the method proceeds from 219 along the “YES” path to 223. In 223 it is determined whether the meeting invitations are ready to send out. If they are not ready for some reason (e.g., changes to the text of the meeting invitation, further invitees to add, etc.) the method proceeds from 223 along the “NO” path back to 205 to further edit the meeting invitations. However, if the meeting invitations are ready to send, the method proceeds from 223 along the “YES” path to 301 of FIG. 3 to send the invitations, monitor the responses, and set up the meeting.

FIG. 3 is a flowchart depicting a method 300 for sending invitations with dependency rules and setting up a meeting according to various exemplary embodiments. The method begins at 301 where the invitations are sent out to the invitees. Quite often the system is set up to send invitations by email. However, in accordance with various embodiments, other means of communication may be used such as text messages or pages, instant messaging, recorded messages sent by telephone, or other like types of communication known to those of ordinary skill in the art. Responses to the invitations are typically returned by the same method of communication as used to send the meeting invitation. However, in some instances it may be more convenient to respond by a different method of communication. For example, people sometimes download emails to a laptop computer for review at a later time, away from the office. If a meeting invitation email is being reviewed in a location not conducive to sending email (e.g., an airport without WiFi), it may be easier to respond by sending a text message from the invitee's cellular phone or pager. In various embodiments, the response may be returned back by any prearranged method of communicating, including those mentioned above for sending the meeting invitations. Once the meeting invitation has been sent in 301 the method proceeds to 303.

In 303 it is determined whether or not any invitees have responded to the meeting invitation. If, in 303, it is determined that a response has not yet been received, the method proceeds from 303 along the “NO” path to loop back around to 305 and wait for a response. Once a response has been received, the method proceeds from 303 along the “YES” path to 307 to determine whether the response is a positive response accepting the meeting invitation, or a negative response declining the meeting invitation. In 307 the response is interpreted to find out whether the invitee can attend the meeting. If it is determined in 307 that the invitee does indeed plan to attend the meeting, the method proceeds from 307 along the “YES” path to 313 to determine whether more invitee responses are expected. If the system expects to receive more responses back the method proceeds from 313 along the “YES” path back to 303 to wait for additional responses.

Back in 307, if it is determined that the invitee cannot attend the meeting, the method proceeds from 307 along the “NO” path to 309 to find out whether that invitee's attendance is required in order to hold the meeting. If the invitee who declined the invitation must be at the meeting in order for the meeting to be held (i.e., is mandatory for the meeting to be held), the method proceeds along the “REQ'D ATTENDANCE” path from 309 to 321 to cancel the meeting. In 321 the meeting resources are released. This may entail, for example, canceling the room reservation and releasing other resources reserved for the meeting such as overhead projectors, food orders, teleconference system reservations, etc. Block 321 may also involve notifying personnel engaged to support the meeting, etc. In addition, a meeting cancellation notice is sent out as part of 321 to all the invitees—or at least to the invitees who responded positively and those who have not yet responded. Once the meeting cancellation is completed in 321 the method proceeds to 325 and ends.

Returning to 309, in some instances an invitee's contributions may be required for the meeting, but may be delegated to another person. For example, it may be necessary to have the marketing manager's inputs at a business meeting, but the marketing manager's assistant may be able to stand in for the marketing manager if the marketing manager cannot attend. In such situations where a substitute is available, a dependency rule can be created. If a dependency rule was previously created for the invitee (e.g., in 217 of FIG. 2) then the method proceeds from 309 along the “DEPENDENCY RULE EXISTS” path to 311. In some embodiments, the system may provide the invitee with the option to create a dependency rule. For example, the person may be a required attendee, but may be able to specify a substitute who can attend in his place. This option avoids canceling the meeting along the path proceeding from 309 through block 321. If the required attendee is to create a dependency rule, the method proceeds from 309 via the “CREATE DEPENDENCY RULE” branch to 315. Part of creating a dependency rule in 315 involves naming a substitute to attend the meeting. Once a substitute has been named, the system sends a meeting invitation to the substitute. Upon completing the dependency rule in 315, the method proceeds from 315 to 311 to determine whether the substitute can attend the meeting.

The activities of block 311 involve determining whether a substitute can attend the meeting, if the person for whom he is substituting cannot attend. If the person who cannot attend is a mandatory attendee, then the meeting will be contingent upon the substitute being able to attend in that person's place. If it is determined in 311 that the substitute cannot attend the meeting to fill in for the required attendee, the method proceeds from 311 along the “NO” path to 321 to cancel the meeting. If no response has been received from the substitute, the method proceeds from 311 along the “NO RESPONSE” path back to 303 to wait for a response. However, if the system determines in 311 that the substitute can attend the meeting, the method proceeds from 311 along the “YES” path to 313 to determine whether any more responses are expected from invitees. Once a predefined condition has been met in 313 for a sufficient number of received responses, the method proceeds from 313 along the “NO” path to take steps for either finalizing the meeting preparations or canceling the meeting. Referring to 313, in some situations (e.g., small meetings), the system may wait to receive all responses back before proceeding to 317 and taking steps to finalize the meeting. In other situations, the system may wait to receive a predetermined percentage of the response back (e.g., 50%, 90%, or any other percentage between 0% and 100%). In some implementations, block 313 may require that all responses from the required attendees (if any) have been received back before taking steps to finalize the meeting. In yet other situations, the system may be configured to continue accepting meeting invitation responses back until a predefined time period has elapsed, or until the occurrence of a given time (e.g., until 24 hours before the scheduled start of the meeting). In some embodiments, once enough responses-including the required attendees-have been received to go ahead with the meeting, the system may take steps to finalize the meeting, but continue accepting responses up until the time of the meeting. Returning to 313, if the system expects to receive more responses back before taking steps to finalize the meeting (and the time has not expired for receiving responses) the method proceeds from 313 along the “YES” path back to 303 to wait for additional responses. However, if it is determined in 313 that no more response are expected, or if the time for receiving responses has expired, the method proceeds from 313 along the “NO” path to 317 to determine whether a sufficient number of responses have been received to set up the meeting. In 317 there may be a requirement that the meeting include a given number of people with certain competencies or skills (e.g., architects, development team leader, business analysts, or the like). In such situations block 317 may entail tallying up the number of the required skill positions to determine whether there have been sufficient responses to continue with the meeting. In addition, block 317 may entail verifying that any required prerequisites have been satisfied. The meeting prerequisites may include requirements that certain attendees have read through materials for the meeting (e.g., design documents, specifications, contracts, or the like) or have attended necessary training before the meeting.

In 317, if it is determined that not enough positive responses have been received to hold the meeting, the method proceeds along the “NO” branch to 321 and the meeting is canceled. However, if it is determined in 317 that a sufficient number of invitees have responded to set up the meeting-and all the required invitees and dependency rule invitees have responded positively-then the method proceeds from 317 along the “YES” path to 319. In 319 the meeting parameters and resources are finalized. Typically, this involves preparing a final meeting notice to be sent out to the invitees. In some implementations the meeting notice may be sent out only to those invitees who have responded positively to the meeting invitation, that is, accepted the meeting invitation. In other implementations the meeting notice may also be sent out to invitees who have not yet responded, or to all invitees, including those who declined the meeting. Another part of block 319 involves finalizing any required preparations for the meeting, including finalizing the resources to be used in carrying out the meeting. This may entail ordering, or confirming, the room for the meeting, slide projectors, teleconference lines, food, administrative support, or other like types of resources required for the meeting. Upon finalizing the meeting parameters and resources in 319 the method proceeds to 323 to send out the final meeting notices. Once the meeting notices have been sent out, the meeting set up is completed, and the method proceeds to 325 and ends.

FIG. 4 is an information technology system 400 suitable for implementing and practicing various exemplary embodiments of the meeting coordination system with dependency rules. Quite often, a company or organization will interconnect the various computers of their operation with a LAN or other such network so that the employees can access computer applications and information for business communications. FIG. 4 depicts a wireless LAN 401 connecting desktop computer 403-405, laptop computer 407, and the computer represented by block diagram 409. Other devices such as a wireless handset 435 (e.g., a cellular telephone or pager), a personal digital assistant (PDA) 433, or other such communication devices may be in communication with the computer network 400 either directly (e.g., via the wireless LAN 401) or by way of the Internet 450 or other network such as the public switched telephone network (PSTN) or a wireless network 451. The computers 403-409, the wireless LAN 401, the wireless handset 435 and PDA 433 are shown as examples in order to illustrate and explain an exemplary information handling system suitable for practicing the various embodiments. In practice, an organization may have many dozens—or even hundreds—of computers or information handling devices interconnected using one or more wired or wireless networks or other communications links. In some instances, a company may employ stand-alone computers not interconnected by any sort of network or links, or a combination of networked computers and stand-alone computers. Generally, however, most modern businesses facilitate communication between the computers of their employees by using a network to interconnect them. The network is also often used to provide access to the Internet 450 so that the employees may communicate and exchange information with the outside world, for example, via email.

Typically, a computer system such as the computer system 409 includes a processor 411 which may be embodied as a microprocessor or central processing unit (CPU). The processor 411 is typically configured to access an internal memory 413 via a bus such as the system bus 431. The internal memory 413 may include one or more of random access memory (RAM), read-only memory (ROM), cache memory, or a combination of these or other like types of circuitry configured to store information in a retrievable format. In some implementations the internal memory 413 may be configured as part of the processor 411, or alternatively, may be configured separate from it but within the same packaging. The processor 611 may be able to access internal memory 413 via a different bus, or via control lines (e.g., local bus 415) than it uses access the other components of computer system 409.

The computer system 409 also typically includes, or has access to, one or more storage drives 417 (or other types of storage memory) and floppy disk drives 419. The storage drive 417 is often a hard disk drive configured for the storage and retrieval of data, computer programs or other information. The storage drive 417 need not necessary be contained within the computer system 409. For example, in some embodiments the storage drive 417 may be server storage space within a network or the Internet that is accessible to the computer system 409 for the storage and retrieval of data, computer programs or other information. For example, the computer system 409 may use storage space at a server storage farm accessible by the Internet 450 or other communications lines. The floppy disk drives 419 may include a combination of several disc drives of various formats that can read and/or write to removable storage media (e.g., CD-R, CD-RW, DVD, DVD-R, floppy disk, etc.). The computer system 409 may either include the storage drives 417 and floppy disk drives 419 as part of its architecture (e.g., within the same cabinet or enclosure and/or using the same power supply), as connected peripherals, or may access the storage drives 417 and floppy disk drives 419 over a network, or a combination of these. The storage drive 417 is often used to store the software, instructions and programs executed by the computer system 409, including for example, all or parts of the computer application program for project management task prioritization.

The computer system 409 may include communication interfaces 421 configured to be communicatively connected to the Internet, a local area network (LAN), a wide area network (WAN), or connect with other devices using protocols such as the Universal Serial Bus (USB), the High Performance Serial Bus IEEE-1394 and/or the high speed serial port (RS-232). The various computers 403-409 may be connected to the Internet via the wireless router 401 (or a wired router or other node—not show) rather than have a direct connected to the Internet. The components of computer system 409 may be interconnected by a bus 431 and/or may include expansion slots conforming to any of various industry standards such as PCI (Peripheral Component Interconnect), ISA (Industry Standard Architecture), or EISA (enhanced ISA).

Typically, the computer system 409 includes one or more user input/output devices such as a keyboard and/or mouse 423, or other means of controlling the cursor (e.g., touchscreen, touchpad, joystick, trackball, etc.) represented by the user input devices 425. A display 427 is also generally included as part of the computer system 409. The display may be any of several types of displays, including a liquid crystal display (LCD), a cathode ray tube (CRT) monitor, a thin film transistor (TFT) array, or other type of display suitable for displaying information for the user. The display 427 may include one or more light emitting diode (LED) indicator lights, or other such display devices. In addition, most computer systems 409 also include, or are connected to, one or more speakers and microphones 429 for audio output and input. Speech recognition software may be used in conjunction with the microphones 429 to receive and interpret user speech commands.

For illustrative purposes, the discussion in this disclosure refers to meetings being set up for employees of a company. In practice, however, the various embodiments may be used to set up any type of meeting for any type of organization or group of people.

Various method activities may be included or excluded as described above, or performed in a different order than shown in the figures, and still remain within the scope of at least one exemplary embodiment. For example, in some implementations the system may send invitations in 301 to the required attendees and wait to get their responses back before sending invitations to others. In this way, the system can avoid having to cancel a meeting (along the path from 309 to 321) because a required attendee cannot be at the meeting. It is understood that the scope of the present invention encompasses other such block diagram omissions, additions, or changes to the flow chart and figures.

The invention may be implemented with any sort of processing units, processors and controllers (e.g., processor 411 of FIG. 4) capable of performing the stated functions and activities. For example, the processor 11 (or other processors used to implement the embodiments) may be a microprocessor, microcontroller, DSP, RISC processor, or any other type of processor that one of ordinary skill would recognize as being capable of performing the functions or activities described herein. A processing unit in accordance with at least one exemplary embodiment can operate computer software programs stored (embodied) on a computer-readable medium such as the internal memory 413, the storage drive 417, or other type of machine-readable medium, including for example, floppy disks, optical disks, a hard disk, CD, flash memory, ram, or other type of machine readable medium as recognized by those of ordinary skill in the art.

The computer software products or application programs can aid in the performance of, or perform, the various steps and activities described above. For example computer programs in accordance with at least one exemplary embodiment may include: source code for sending a meeting invitation to each of the invitees, wherein the meeting is contingent upon a dependency rule associated with one of the invitee's attendance; source code for receiving responses from at least some of the invitees including positive responses from invitees subject to any dependency rules; source code for continuing with the setting up of the meeting based upon the positive response from the second invitee which meets the conditions of said dependency rule; and source code for the other activities illustrated in the figures or otherwise described herein.

The use of the word “exemplary” in this disclosure is intended to mean that the embodiment or element so described serves as an example, instance, or illustration, and is not necessarily to be construed as preferred or advantageous over other embodiments or elements. The description of the various exemplary embodiments provided above is illustrative in nature and is not intended to limit the invention, its application, or uses. Thus, variations that do not depart from the gist of the invention are intended to be within the scope of the embodiments of the present invention. Such variations are not to be regarded as a departure from the spirit and scope of the present invention.

What is claimed is:

1. A computer implemented method of setting up a meeting schedule comprising steps of:
sending a meeting invitation to each of a plurality of invitees including a first invitee and a second invitee, wherein said meeting is contingent upon a dependency rule associated with the second invitee's attendance;
receiving responses from at least some of the plurality of invitees including a positive response from the second invitee; and
continuing with the setting up of the meeting based upon the positive response from the second invitee which meets the conditions of said dependency rule.

2. The method of setting up the meeting schedule according to claim 1, wherein said dependency rule specifies that the second invitee must attend the meeting if the first invitee cannot attend the meeting.

3. The method of setting up the meeting schedule according to claim 1, wherein said dependency rule specifies that the second invitee must attend the meeting if the first invitee attends the meeting.

4. The method of setting up the meeting schedule according to claim 1, wherein said dependency rule specifies that attendance of at least one of the first invitee and the second invitee is mandatory for the meeting schedule to continue.

5. The method of setting up the meeting schedule according to claim 4, further comprising:
receiving a negative response from the first invitee.

6. The method of setting up the meeting schedule according to claim 1, wherein the first invitee sets up the dependency rule associated with the second invitee's attendance.

7. The method of setting up the meeting schedule according to claim 6, wherein the responses from at least some of the plurality of invitees comprise positive responses from any mandatory attendees who have responded to the meeting invitation.

8. The method of setting up the meeting schedule according to claim 7, further comprising:
sending out a final meeting notice confirming the meeting schedule;
wherein the sending of the final meeting notice is contingent upon receiving the positive responses from said mandatory attendees and the positive response from the second invitee meeting the conditions of said dependency rule.

9. A software product comprising a machine readable medium including a program of instructions for setting up a meeting schedule, wherein the program of instructions upon being executed on a device causes the device to perform activities comprising:
sending a meeting invitation to each of a plurality of invitees including a first invitee and a second invitee, wherein said meeting is contingent upon a dependency rule associated with the second invitee's attendance;
receiving responses from at least some of the plurality of invitees including a positive response from the second invitee; and
continuing with the setting up of the meeting based upon the positive response from the second invitee which meets the conditions of said dependency rule.

10. The software product according to claim 9, wherein said dependency rule specifies that the second invitee must attend the meeting if the first invitee cannot attend the meeting.

11. The software product according to claim 9, wherein said dependency rule specifies that the second invitee must attend the meeting if the first invitee attends the meeting.

12. The software product according to claim 9, wherein said dependency rule specifies that attendance of at least one of the first invitee and the second invitee is mandatory for the meeting schedule to continue.

13. The software product according to claim 12, the activities further comprising:
receiving a negative response from the first invitee.

14. The software product according to claim 9, wherein the first invitee sets up the dependency rule associated with the second invitee's attendance, and wherein the responses from at least some of the plurality of invitees comprise positive responses from any mandatory attendees who have responded to the meeting invitation, the activities further comprising:
sending out a final meeting notice confirming the meeting schedule;
wherein the sending of the final meeting notice is contingent upon receiving the positive responses from said mandatory attendees and the positive response from the second invitee meeting the conditions of said dependency rule.

15. A system configured to set up a meeting schedule, the system comprising:
an electronically readable storage medium configured to store a meeting invitation sent to each of a plurality of invitees including a first invitee and a second invitee, wherein said meeting is contingent upon a dependency rule associated with the second invitee's attendance;
a display device configured to display responses received from at least some of the plurality of invitees including a positive response from the second invitee; and
a processor configured to execute instructions to continue with the setting up of the meeting based upon the positive response from the second invitee which meets the conditions of said dependency rule.

16. The system according to claim 15, wherein said dependency rule specifies that the second invitee must attend the meeting if the first invitee cannot attend the meeting.

17. The system according to claim 15, wherein said dependency rule specifies that the second invitee must attend the meeting if the first invitee attends the meeting.

18. The system according to claim 15, wherein said dependency rule specifies that attendance of at least one of the first invitee and the second invitee is mandatory for the meeting schedule to continue.

19. The system according to claim 15, wherein the first invitee sets up the dependency rule associated with the second invitee's attendance, and wherein the responses from at least some of the plurality of invitees comprise positive responses from any mandatory attendees who have responded to the meeting invitation, said processor further being configured to execute instructions to:
send out a final meeting notice confirming the meeting schedule;
wherein the sending of the final meeting notice is contingent upon receiving the positive responses from said mandatory attendees and the positive response from the second invitee meeting the conditions of said dependency rule.
